(19) United States
(12) Patent Application Publication
(10) Pub. No.: US 2023/0228212 A1
(43) Pub. Date: Jul. 20, 2023

(54) CYLINDER HEAD FOR INTERNAL COMBUSTION ENGINE

(71) Applicant: TOYOTA JIDOSHA KABUSHIKI KAISHA, Aichi (JP)

(72) Inventor: Kei OKABE, Susono-shi (JP)

(21) Appl. No.: 18/097,290

(22) Filed: Jan. 16, 2023

(30) Foreign Application Priority Data
Jan. 17, 2022 (JP) 2022-005058

(51) Int. Cl. F02B 23/10; F02F 1/42; F01L 3/06; F02F 1/24

(52) U.S. Cl. CPC F02B 23/101; F02F 1/4285; F01L 3/06; F02F 1/242; F02B 2023/106

(57) ABSTRACT

A cylinder head of an engine in which a thermal stress acting between a valve seat made of clad material and a base metal is reduced. The cylinder head comprises: an inner wall surface; a pair of intake ports arranged adjacent to each other; a valve seat formed of clad material around each intake port; a mask section formed within a predetermined range of a circumference of each intake port to protrude toward a combustion chamber; and a cavity formed between a pair of the mask sections by partially depressing the inner wall surface toward the combustion chamber.

The present disclosure claims the benefit of Japanese Patent Application No. 2022-005058 filed on Jan. 17, 2022 with the Japanese Patent Office, the disclosure of which is incorporated herein by reference in its entirety.

### BACKGROUND

### Field of the Disclosure

The present disclosure relates to a cylinder head of an internal combustion engine such as a gasoline engine. More specifically, the present disclosure relates to a cylinder head having a mask section for suppressing an airflow disturbing a tumble flow, in which valve seats of intake valves are made of clad material.

### Discussion of the Related Art

JP-A-2019-190285 describes one example of a cylinder head having a mask section. In order to certainly burn air-fuel mixture by smoothly propagating fire during lean operation (i.e., stratified charge combustion) in which the air/fuel ratio is increased, it is preferable to create a tumble flow in a combustion chamber. Specifically, the tumble flow is a longitudinal spiral flow of the air introduced into the combustion chamber, in which the air introduced into the combustion chamber flows along a ceiling, further flows downwardly along an inner surface of a cylinder, and further flows toward an intake port along an upper surface of a piston. In order to create such tumble flow, an intake pipe opening toward the intake ports of the combustion chamber is inclined with respect to the combustion chamber at an acute angle thereby guiding the air flowing from the intake ports toward the ceiling of the combustion chamber.

However, when the intake valve is isolated from the valve seat to open the intake port, the air flows into the combustion chamber from around the intake valve. In this situation, the air also flows into the combustion chamber from a section of a periphery of the intake valve or the intake port opposite to the center of the combustion chamber (or an exhaust port). That is, the air also flows in an opposite direction to the tumble flow thereby disturbing the tumble flow. In order to damp such counter flow against the tumble flow, the mask section is formed on the cylinder head. Specifically, the mask section is an arcuate wall-shaped section formed on the periphery of the intake port in the opposite side to the exhaust port, and the mask section extends in a radially outer side of the valve seat of the intake port in a stroke direction of the intake valve.

In order to adjust an angle of the intake pipe to a desired angle to create a tumble flow, in the conventional art, the valve seats are formed of the clad material. For example, the valve seat according to the conventional art is manufactured by spraying clad powders to the opening end of the intake port under a non-oxidizing atmosphere while irradiating laser radiation to fuse the clad powders. Consequently, the clad powders and base metal (e.g., aluminum alloy) of the cylinder head are heated, and eventually the heats of the clad powders and the base metal are radiated so that the clad powders and the base metal are cooled. However, coefficients of thermal expansion of the fused clad powders and the base metal are different from each other, and hence the fused clad powders and the base metal are subjected to a thermal stress. In this situation, since the coefficient of thermal expansion of the clad powders is greater than the coefficient of thermal expansion of the base metal, such thermal stress would act as a tensile stress as a result of thermal shrinkage of the fused clad powders.

Specifically, such tensile stress acts on an entire circumference of the valve seat on which the clad powders are fused, and partially increases at the mask section. That is, a rigidity and a thermal capacity of the base metal are enhanced by the mask section thereby increasing the thermal shrinkage of the fused clad powders (or the valve seat) greater than that of the base metal, and consequently the tensile stress acting between the fused clad powders and the base metal. As a result, the fused clad powders would be separated from the base metal or a crack would be created between the fused clad powders and the base metal. For this reason, the tumble flow would be disturbed and a fuel efficiency would be reduced.

### SUMMARY

Aspects of preferred embodiments of the present disclosure have been conceived noting the foregoing technical problems, and it is therefore an object of the present disclosure to provide a cylinder head of an internal combustion engine in which a thermal stress acting between a valve seat made of clad material and a base metal is reduced.

An exemplary embodiment of the present disclosure relates to a cylinder head for an internal combustion engine. In order to achieve the above-explained objective, according to the exemplary embodiment of the present disclosure, the cylinder head is provided with: an inner wall surface serving as an inner surface of a combustion chamber; a pair of intake ports arranged adjacent to each other while maintaining a predetermined clearance therebetween, each of which penetrates through the inner wall surface to open toward the combustion chamber; a valve seat that is formed of clad material all around an open end of each of the intake ports; a mask section that is formed within a predetermined range of a circumference of each of the intake ports to protrude from the circumference of the intake port toward the combustion chamber; and a cavity having a predetermined shape and a bottom that is formed between a pair of the mask sections by partially depressing the inner wall surface toward the combustion chamber.

In a non-limiting embodiment, the cavity may be positioned at an intermediate position between the pair of the intake ports. A clearance between the open ends of the pair of the intake ports may be narrowest on a line passing through centers of the intake ports, and may gradually widened toward both sides of the line passing through the centers of the intake ports. In addition, the cavity may have a shape in which a side extending parallel to the line passing through the centers of the intake ports at a site where the clearance between the open ends of the intake ports is narrowest is shorter, and a side extending parallel to the line passing through the centers of the intake ports at a site where the clearance between the open ends of the intake ports is widest is longer.

In a non-limiting embodiment, the cylinder head may be further provided with a pair of exhaust ports arranged parallel to the line passing through the centers of the intake ports. In addition, the mask section may be formed within the predetermined range of the circumference of each of the intake ports in an opposite side of the exhaust port, and the cavity may be formed in an opposite side of the exhaust ports across the line passing through the centers of the intake ports.

In a non-limiting embodiment, one end of each of the mask sections may be located at a site where the clearance between the open ends of the intake ports is narrow, in the opposite side of the exhaust ports across the line passing through the centers of the intake ports. In addition, the cavity may overlap at least partially with the one ends of the mask sections adjacent to each other.

In a non-limiting embodiment, the cavity may have a geometric center of a planar shape thereof viewed from the combustion chamber. In addition, the cavity may be arranged at a site where the geometric center of the cavity is situated within a range between: a line passing through the center of the intake port and the one end of the mask section; and the line passing through the centers of the intake ports.

In a non-limiting embodiment, the cylinder head may be further provided with an installation hole formed on the inner wall surface between the pair of exhaust ports and the line passing through the centers of the intake ports, and a fuel injector may be installed in the installation hole.

In the cylinder head according to the exemplary embodiment of the present disclosure, the clad material of the valve seat is thermally expanded when fused thermally and shrunk after cooled. As a result, an inner circumference of the intake port is shrunk toward the center of the intake port by a thermal stress created due to shrinkage of the clad material of the valve seat. Especially, a portion between the mask sections of the pair of the intake ports are subjected to strong tensile force resulting from shrinkage of clad materials of the valve seat on both sides. Whereas, the cavity is formed between the mask sections so that the thickness of the inner wall surface of the combustion chamber is reduced. That is, a rigidity and a thermal capacity of the inner wall surface of the combustion chamber are reduced partially by the cavity. Therefore, the portion of the inner wall surface on which the cavity is formed is easily to be deformed by the tensile force. In addition, since the thermal capacity of the portion of the inner wall surface on which the cavity is formed is reduced, a temporal temperature difference therein and a resultant thermal stress acting thereon may be relaxed. Thus, although a volume of the cylinder head is increased by the mask sections, the thermal. stress may be relaxed by the cavity thereby preventing separation and cracking of the clad material of the valve seat. According to the exemplary embodiment of the present disclosure, therefore, a combustion rate of the air-fuel mixture may he increased so that a fuel efficiency of the internal combustion engine is improved.

In addition, according to the exemplary embodiment of the present disclosure, the width of the cavity is changed in accordance with a change in the clearance between the pair of intake ports. According to the exemplary embodiment of the present disclosure, therefore, unevenness of the rigidity and the thermal capacity of the portion between the pair of intake ports may be reduced. For this reason, separation and cracking of the clad material of the valve seat due to thermal shrinkage resulting from the tensile stress may be prevented certainly.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1. is a schematic illustration showing one example of a structure of an internal. combustion engine having an air intake and exhaust system;

FIG. 2 is a partial cross-sectional view showing a cross-section of one of cylinders;

FIG. 3 is a partial perspective view partially showing a bottom side of a cylinder head;

FIG. 4 is a partial cross--sectional view showing a cross-section of one of intake ports;

FIG. 5 is a perspective view showing positions of a valve seat, a mask section, and a cavity in one of the intake ports;

FIG. 6 is a top plan view schematically showing configurations of the cavity;

FIG. 7 is a cross-sectional view showing a cross-section of the cavity along the line shown in FIG. 6; and

FIG. 8 is a graph showing a measurement result of distribution of a vertical stress.

### DETAILED DESCRIPTION OF THE PREFERRED EMBODIMENT(S)

Embodiments of the present disclosure will now be explained with reference to the accompanying drawings. Note that the embodiments shown below are merely examples the present disclosure, and do not limit the present disclosure.

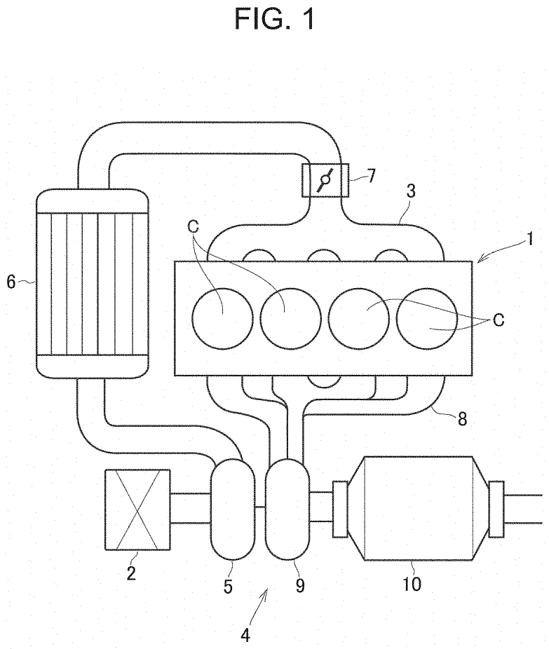

Turning no to FIG. 1, there is shown one example of a structure of an internal combustion engine (hereinafter simply referred to as engine) 1 as a conventional gasoline engine to which the exemplary embodiment of the present disclosure is applied. As illustrated in FIG. 1, the engine 1 comprises a plurality of cylinders C, and the engine 1 generates a mechanical power by burning air-fuel mixture in the cylinders C. To this end, air aspirated by an air cleaner 2 is distributed to the cylinders C through an intake manifold 3. The air may be aspirated not only naturally by the air cleaner 2 but also by a supercharger. According to the exemplary embodiment of the present disclosure, the engine 1 shown in FIG. 1 is provided with a turbocharger 4. Specifically, the air cleaner 2 is connected to an intake side of a compressor 5 of the turbocharger 4, and an intercooler 6 is connected to a discharge side of the compressor 5. A throttle valve 7 is disposed on a pipe connecting the intercooler 6 to the intake manifold 3. On the other hand, an exhaust manifold 8 is connected to an exhaust inlet of a turbine 9, and an exhaust gas purification catalyst (i.e., a catalyst converter) 10 is connected to an exhaust outlet of the turbine 9.

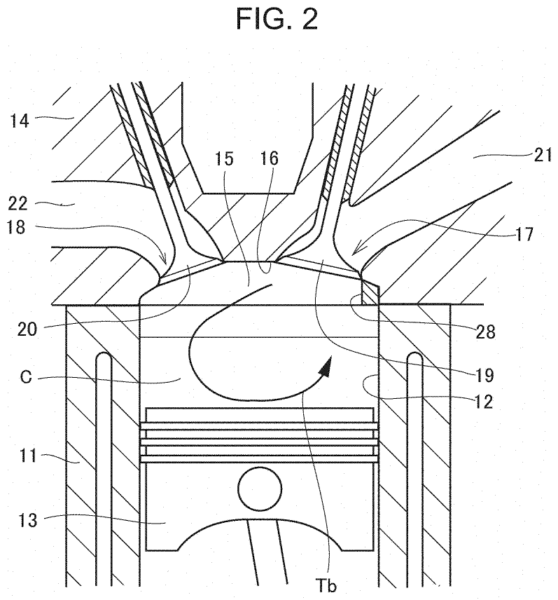

A structure of the cylinder C is shown in FIG. 2 in more detail. As illustrated in FIG. 2, a piston 13 is inserted into a bore 12 of a cylinder block 11 while being allowed to reciprocate in a direction along a center axis thereof. A cylinder head 14 is attached to an upper section of the cylinder block 11, and a depression is formed on the cylinder head 14 to serve as a combustion chamber 15 together with a piston head of the piston 13. An intake port (i.e., a suction inlet) 17 and an exhaust port (i.e., an exhaust outlet) 18 are formed on an inner wall surface (i.e., a ceiling surface) 16 of the combustion chamber 15. An intake valve 19 is inserted into the intake port 17, and an exhaust valve 20 is inserted into the exhaust port 18, respectively. Therefore, the intake port 17 is intermittently closed by the intake valve 19, and the exhaust port 18 is intermittently closed by the exhaust valve 20. The ceiling surface 16 of the combustion chamber 15 is shaped into a pent roof-shape or a hemispherical shape depending on the number of the intake ports 17 and the exhaust ports 18 or the number of intake valves 19 and the exhaust valves 20.

In the descriptions of the present disclosure, the definition of the “vertical direction” includes the reciprocating direction of the piston 13.

That is, a pair of the intake ports 17 and a pair of the intake valves 19 are arranged in each of the cylinders C. Likewise, a pair of the exhaust ports 18 and a pair of the exhaust valves 20 are arranged in each of the cylinders C. Specifically, in each of the cylinders C, the pair of the intake ports 17 to which the intake valve 19 is inserted respectively is arranged along a line extending parallel to a center axis of a crankshaft (not shown), and the pair of the exhaust ports 18 to which the exhaust valve 20 is inserted respectively is arranged parallel to the pair of the intake ports 17, that is, also parallel to the line extending parallel to the center axis of a crankshaft. The intake ports 17 and the exhaust ports 18, that is, the intake valves 19 and the exhaust valves 20 are arranged in a direction perpendicular to the center axis of the crankshaft (i.e., in the horizontal direction in FIG. 2).

The intake port 17, the intake valve 19, and the piston head are shaped into configurations possible to create a tumble flow Tb in the combustion chamber 15. Specifically, the tumble flow Tb indicated by the curved arrow in FIG. 2 is a flow of the intake air or the air-fuel mixture in which a vertical motion component is greater. Although not especially shown in FIG. 2, an ignition plug is arranged at the center of the ceiling surface 16, and an injector is arranged on the ceiling surface 16 at a site closer to the intake port 17 than the ignition plug to inject the fuel directly to the combustion chamber 15.

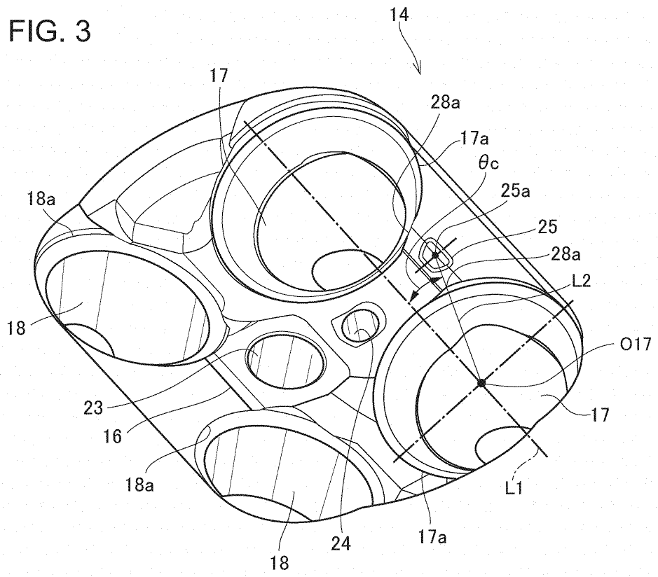

FIG. 3 is a partial perspective view showing a bottom surface of the cylinder head 14, and in FIG. 3, the intake valve 19, the exhaust valve 20, the ignition plug, and the injector are omitted. As illustrated in FIG. 3, the ceiling surface 16 is shaped into a pent roof shape, and the intake ports 17 and the exhaust ports 18 are formed on each corner of a rectangular section which is longer in a direction along the center axis of the crankshaft. Specifically, each of the intake ports 17 has a circular open end 17a opening toward the combustion chamber 15, and individually connected to an inlet conduit 21 penetrating through the cylinder head 14. That is, the intake port 17 serves as an opening of the inlet conduit 21. Likewise, each of the exhaust ports 18 has a circular open end 18a opening toward the combustion chamber 15, and individually connected to an exhaust conduit 22 penetrating through the cylinder head 14. That is, the exhaust port 18 serves as an opening of the exhaust conduit 22.

An installation hole 23 is formed on the center of a site surrounded by the intake ports 17 and the exhaust ports 18, and the ignition plug is installed in the installation hole 23. Whereas, an installation hole 24 is formed adjacent to the installation hole 23 between the intake ports 17, and the injector is installed in the installation hole 24. In other words, the installation hole 24 is formed closer to the intake ports 17 than the installation hole 23 in the direction perpendicular to the center axis of the crankshaft. That is, the injector is arranged between a pair of the intake ports 17. A cavity 25 as a depression is formed on the ceiling surface 16 in an opposite side of the installation hole 24 across a center line L1 of the intake valves 19 passing through centers O17 of the pair of the intake ports 17.

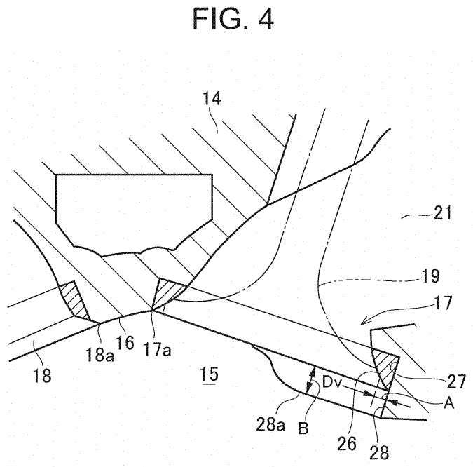

Here will be explained the intake port 17 and the cavity 25 in more detail with reference to FIG. 4. FIG. 4 shows a cross-section of one of the intake ports 17 along a line perpendicular to the center line L1 of the intake valves 19. As illustrated in FIG. 4, a valve seat 26 is arranged all around the open end 17a of the intake port 17. To this end, a counterbore 27 is formed by processing a base metal (e.g., aluminum alloy) of the open end 17a of the intake port 17, and the valve seat 26 is formed by filling the counterbore 27 with predetermined metal powder by a laser clad processing. Specifically, metal powder having different heat conductivity and thermal expansion coefficient from those of the base metal of the cylinder head 14 is used to form the valve seat 26. For example, the valve seat 26 may be formed by the method described in a publication of Japanese patent No. 6210093.

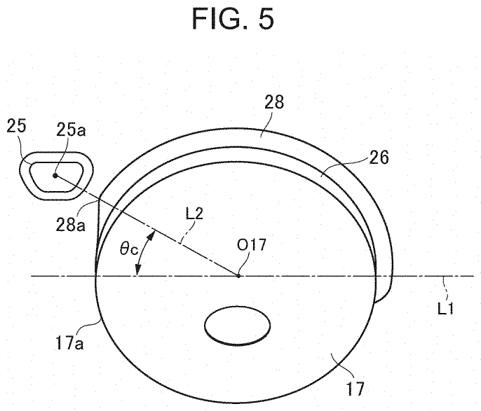

In order to control air intake, a mask wall (or mask section) 28 is formed within a predetermined range of a circumference of the open end 17a of the intake port 17 to protrude from an end portion of the valve seat 26 toward the combustion chamber 15. According to the example shown in FIG. 4, the mask section 28 protrudes from a side wall of the counterbore 27 in a stroke direction of the intake valve 19 toward the combustion chamber 15. The range where the mask section 28 is formed is schematically shown in FIG. 5. Here, it is to be noted that FIG. 5 is merely a schematic illustration, and hence details of the foregoing elements are not completely identical to those shown in FIG. 3. In the example shown in FIG. 5, the mask section 28 is formed on the circumference of the intake port. 17 within a range of approximately 180 degrees in the opposite side of the exhaust port 18. That is, the mask section 28 is an arcuate wall formed around the open end 17a of the intake port 17.

Each end portion of the mask section 28 inclines respectively so that a height of each of the end portions of the mask section 28 increases (or decreases) gradually. One end 28a of the mask section 28 is located between the pair of the intake ports 17 arranged in the direction parallel to the center line L1 of the intake valves 19. Specifically, the one end 28a of the mask section 28 is located at a site where an angle θc between: a line L2 passing through the center O17 of the intake port 17 and the one end 28a; and the center line L1 of the intake valves 19, is approximately 30 degrees. According to the exemplary embodiment of the present disclosure, the one end 28a is an end portion of the mask section 28 at which a height thereof is maintained to a designed value. For example, the mask section disclosed in JP-A-2019-190285 may be adopted as the mask section 28.

As described, the mask section 28 is adapted to control the intake air so as to create the tumble flow Tb in the combustion chamber 15. Specifically, the mask section 28 suppresses an airflow in the counter direction of the tumble flow Tb in the combustion chamber 15. To this end, dimensions of the mask section 28 and peripheral sections may be set to desired values based on an experimental result. For example, given that a lifting amount of the intake valve 19 is L, a clearance A between the intake valve 19 and the mask section 28 may be set to satisfy the following inequality:

0.05<A<0.15 L.

Whereas, given that an outer diameter of the intake valve 19 is Dv, a height B of the mask section 28 may be set to satisfy the following inequality:

0.5Dv/L<B<Dv/L.

Specifically, the one end 28a whose height is B is located at a center of a column-shaped straight section of an outer circumferential surface of the closed intake valve 19, and the wall height of the mask section 28 between the one end 28a and the other end of the mask section 28 in the combustion chamber 15 side is set to B.

In the pair of intake ports 17, each of the intake ports 17 is symmetrically shaped about the line perpendicular to the center line L1 passing through. the centers O17 of the pair of the intake ports 17. That is, in the pair of intake ports 17, the one ends 28a of the mask sections 28 are adjacent to each other in the direction parallel to the center line L1.

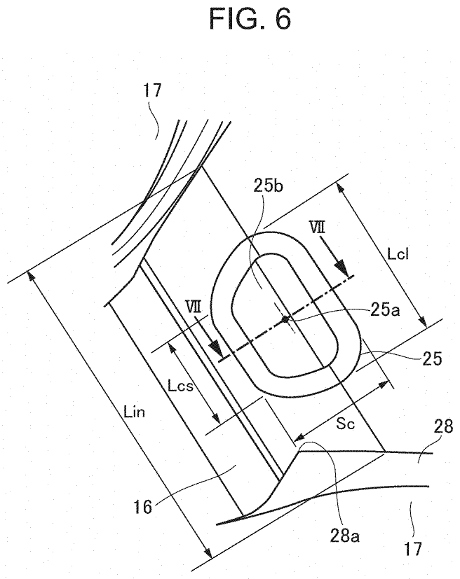

Here will be explained the cavity 25 in more detail. The cavity 25 is a depression formed on the ceiling surface 16 between the intake ports 17 by partially cutting or melting the ceiling surface 16, or casting the cylinder head 14 in such a manner as to partially depress the ceiling surface 16. That is, a thickness of the ceiling surface 16 is reduced in the cavity 25. Turning to FIG. 6, there is shown one example of configurations and a shape of the cavity 25. Here, it is to be noted that FIG. 6 is merely a schematic illustration, and hence details of the foregoing elements are not completely identical to those shown in FIGS. 3 and 5. In the example shown in FIG. 6, the cavity 25 is shaped into D-shape or a rounded trapezoidal shape.

The cavity 25 is formed on an opposite side of the exhaust ports 18 across the center line L1. As illustrated in FIG. 5, a center 25a of the cavity 25 is located on the above-mentioned line L2 passing through the center O17 of the intake port 17 and the one end 28a of the mask section 28. Specifically, the center 25a is a geometric center of a planar shape of the cavity 25 viewed from the combustion chamber 15. That is, given that the cavity 25 is shaped into a trapezoidal shape, the center 25a is located at an intersection of diagonal lines of the cavity 25. The cavity 25 has a predetermined planar dimension around the center 25a, and overlaps at least partially with the one ends 28a of the mask sections 28 adjacent, to each other. In other words, the cavity 25 is located to intersect with a line (not shown) connecting the one ends 28a of the mask sections 28 adjacent to each other.

The cavity 25 thus shaped into a trapezoidal shape is oriented to accord with a change in a clearance between peripheries of the pair of intake ports 17. Specifically, the clearance between the open ends 17a of the pair of the intake ports 17 is narrowest on the center line L1, and gradually widens toward both sides of the center line L1. According to the exemplary embodiment, therefore, a shorter side as an upper bottom of the cavity 25 extends parallel and closer to the center line L1, and a longer side as a lower bottom of the cavity 25 also extends parallel to the center line L1 but further than the shorter side.

Specifically, the cavity 25 is positioned at an intermediate position between the pair of the intake ports 17 in the direction of the center line L1. Accordingly, a width of the cavity 25 in the direction of the center line L1 is narrow at a site where the clearance between the intake ports 17 is narrow, and wide at a site where the clearance between the intake ports 17 is wide. That is, each clearance between the cavity 25 and the intake ports 17 on both sides is individually homogenized.

Here will be explained one example of dimensions of the cavity 25. According to the exemplary embodiment of the present disclosure, a width Lcl of the lower bottom (i.e., a maximum width) of the cavity 25 may be set to

Lc1=0.6Lin

where Lin is a clearance between the pair of the intake ports 17 (or the mask section 28) measured at a same level with the lower bottom of the cavity 25. Whereas, a width Lcs of the upper bottom of the cavity 25 may be set to

Lcs=0.65Lcl.

A height Sc of the cavity 25 having a trapezoidal shape may be set to

0.3Lcl<Sc<0.5Lcl, and

a depth He of the cavity 25 may be set to

0.15t<Hc<0.5t,

where t is a general thickness as a designed thickness of the ceiling surface 16. In other words, the general thickness is a thickness of a widest area where the thickness thereof is even compared to other areas having even thicknesses. That is, the thickness of the ceiling surface 16 is thinner than the general thickness at a portion having a mounting dimension, and thicker than the general thickness at a portion protruding toward the combustion chamber 15 to connect predetermined adjacent portions.

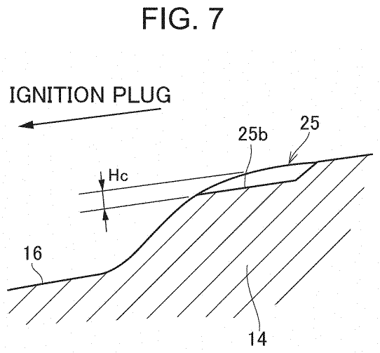

The cavity 25 may be formed not only on a flat site to be surrounded entirely by the wall section, but also on a boundary of a stepped site as illustrated in FIGS. 6 and 7. Specifically, FIG. 6 is a top plan view showing configurations of the cavity 25 formed on a boundary of a stepped site, and FIG. 7 is a cross-sectional view showing a cross-section of the cavity 25 shown in FIG. 6 along the VII-VII line. In the example shown in FIGS. 6 and 7, the cavity 25 is formed on a boundary of a stepped section where the ceiling surface 16 declines gradually from the center of the combustion chamber 15 toward a peripheral section. Here, the FIG. 7 is flipped vertically, and hence the stepped section climbs in FIG. 7. Therefore, the wall section is not formed on the central section of the combustion chamber 15 so that the cavity 25 is joined to the ceiling surface 16, and the wall section is formed on the remaining section toward the ceiling surface 16. In the example shown in FIGS. 6 and 7, the cavity 25 has a depth Hc between a section of the ceiling surface 16 which is not depressed to form the cavity 25 and a bottom surface 25b of the cavity 25 expanding parallel to the ceiling surface 16.

As described, in the cylinder head 14, the counterbore 27 is formed around the open end 17a of the intake port 17 by cutting the open end 17a, and the valve seat 26 is formed by filling the counterbore 27 with predetermined metal powder by a laser clad processing. As a result, a vertical tensile stress acting between the valve seat 26 and the base metal of the cylinder head 14, in other words, a tensile force acting toward the center O17 of the intake port 17 is created due to a temperature rise resulting from the laser clad processing and a temperature drop resulting from a subsequent heat radiation. Whereas, the cavity 25 is formed on the cylinder head 14 so that rigidity of a portion of the cylinder head 14 where the cavity 25 is formed is reduced by the cavity 25. That is, a volume of the base metal of the cylinder head 14 is reduced by the cavity 25. Therefore, a thermal capacity of the portion of the cylinder head 14 where the cavity 25 is formed is reduced. For these reasons, a temperature difference between the valve seat 26 formed of the clad material and the base metal of the cylinder head 14 is reduced during a cooling process, but the portion of the cylinder head 14 where the cavity 25 is formed is deformed by the tensile stress resulting from a reduction in the rigidity thereof at least slightly. Consequently, the tensile stress acting between the valve seat 26 and the base metal of the cylinder head 14 is reduced by the cavity 25 so that the valve seat 26 and the cylinder head 14 will not be separated from each other or cracked.

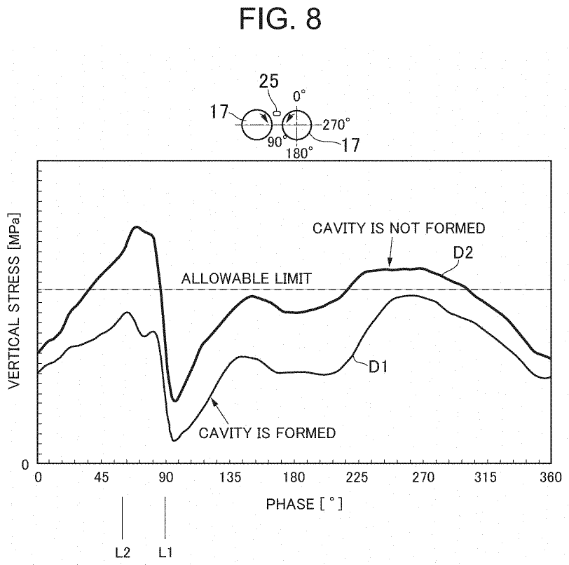

FIG. 8 shows a distribution of the vertical stress measured to confirm an advantage of the cavity 25. In FIG. 8, the curve D1 indicates the vertical stress of the case in which the cavity 25 is formed on the cylinder head 14, and the curve D2 indicates the vertical stress of the case in which the cavity 25 is not formed on the cylinder head 14. In the measurement, a phase of 0 degrees was set to an intersection between the line perpendicular to the center line L1 and the circumference of the intake port 17 on the opposite side of the exhaust port 18, and the vertical stress was measured counterclockwise as a direction of applying the laser clad processing. In FIG. 8, accordingly, the line L2 extends at 60 degrees while passing through the center O17 of the intake port 17 and the one end 28a, and the center line L1 extends at 90 degrees.

As can be seen from FIG. 8, in the case in which the cavity 25 is not formed, the vertical stress exceeds an allowable limit within a range from approximately 36 degrees to approximately 90 degrees and a range from approximately 210 degrees to approximately 300 degrees. By contrast, in the case in which the cavity 25 is formed, the vertical stress changes in a similar manner as the case in which the cavity 25 is not formed, but does not exceed the allowable limit. Thus, the vertical stress is reduced by the cavity 25 thereby preventing separation and cracking between the valve seat 26 and the cylinder head 14.

In the case in which the cavity 25 is not formed, the vertical stress increases significantly within a range from approximately 60 degrees to approximately 90 degrees. Specifically, such angular range corresponds to an angular range from 30 degrees to 0 degrees between the lines L2 and L1. Therefore, in order to reduce the sensile stress in the angular range from 30 degrees to 0 degrees between the lines L2 and L1, the cavity 25 may he arranged at a site where the center of the cavity 25 is situated within the angular range from 30 degrees to 0 degrees between the lines L2 and L1.

Although the above exemplary embodiment of the present disclosure has been described, it will be understood by those skilled in the art that the present disclosure should not be limited to the described exemplary embodiments, and various changes and modifications can be made within the scope of the present disclosure. For example, configuration of the cavity 25 should not be limited to the above-explained D-shape, and may be altered arbitrarily according to need. In addition, a relative position of the cavity 25 with respect to the intake port 17 may also be adjusted according to need. What is claimed is:

1. A cylinder head for an internal combustion engine, comprising:
an inner wall surface serving as an inner surface of a combustion chamber;
a. pair of intake ports arranged adjacent to each other while maintaining a predetermined clearance therebetween, each of which penetrates through the inner wall surface to open toward the combustion chamber;
a valve seat that is formed of clad material all around an open end of each of the intake ports;
a mask section that is formed within a predetermined range of a circumference of each of the intake ports to protrude from the circumference of the intake port toward the combustion chamber; and
a cavity having a predetermined shape and a bottom that is formed between a pair of the mask sections by partially depressing the inner wall surface toward the combustion chamber.

2. The cylinder head as claimed in claim 1,
wherein the cavity is positioned at an intermediate position between the pair of the intake ports,
a clearance between the open ends of the pair of the intake ports is narrowest on a line passing through centers of the intake ports, and gradually widened toward both sides of the line passing through the centers of the intake ports, and
the cavity has a shape in which a side extending parallel to the line passing through the centers of the intake ports at a site where the clearance between the open ends of the intake ports is narrowest is shorter, and a side extending parallel to the line passing through the centers of the intake ports at a site where the clearance between the open ends of the intake ports is widest is longer.

3. The cylinder head as claimed in claim 1, further comprising:
a pair of exhaust ports arranged parallel to the line passing through the centers of the intake ports,
wherein the mask section is formed within the predetermined range of the circumference of each of the intake ports in an opposite side of the exhaust port, and
the cavity is firmed in an opposite side of the exhaust ports across the line passing through the centers of the intake ports.

4. The cylinder head as claimed in claim 2, further comprising:
a pair of exhaust ports arranged parallel to the line passing through the centers of the intake ports,
wherein the mask section is formed within the predetermined range of the circumference of each of the intake ports in an opposite side of the exhaust port, and
the cavity is formed in the opposite side of the exhaust ports across the line passing through the centers of the intake ports.

5. The cylinder head as claimed in claim 3,
wherein one end of each of the mask sections is located at a site where the clearance between the open ends of the intake ports is narrow, in the opposite side of the exhaust ports across the line passing through the centers of the intake ports, and
the cavity overlaps at least partially with the one ends of the mask sections adjacent to each other.

6. The cylinder head as claimed in claim 4,
wherein the one end of each of the mask sections is located at a site where the clearance between the open ends of the intake ports is narrow, in the opposite side of the exhaust ports across the line passing through the centers of the intake ports, and
the cavity overlaps at least partially with the one ends of the mask sections adjacent to each other.

7. The cylinder head as claimed in claim 5,
wherein the cavity has a geometric center of a planar shape thereof viewed from the combustion chamber, and
the cavity is arranged at a site where the geometric center of the cavity is situated within a range between: a line passing through the center of the intake port and the one end of the mask section; and the line passing through the centers of the intake ports.

8. The cylinder head as claimed in claim 6,
wherein the cavity has a geometric center of a planar shape thereof viewed from the combustion chamber, and
the cavity is arranged at a site where the geometric center of the cavity is situated within a range between: a line passing through the center of the intake port and the one end of the mask section; and the line passing through the centers of the intake ports.

9. The cylinder head as claimed in claim 3, further comprising;
an installation hole formed on the inner wall surface between the pair of exhaust ports and the line passing through the centers of the intake ports,
wherein a fuel injector is installed in the installation hole.

10. The cylinder head as claimed in claim 4, further comprising:
an installation hole formed on the inner wall surface between the pair of exhaust ports and the line passing through the centers of the intake ports,
wherein a fuel injector is installed in the installation hole.

11. The cylinder head as claimed in claim 5, further comprising:
an installation hole formed on the inner wall surface between the pair of exhaust ports and the line passing through the centers of the intake ports,
wherein a fuel injector is installed in the installation hole.

12. The cylinder head as claimed in claim 6, further comprising:
an installation hole formed on the inner wall surface between the pair of exhaust ports and the line passing through the centers of the intake ports,
wherein a fuel injector is installed in the installation hole.

13. The cylinder head as claimed in claim 7, further comprising:
an installation hole formed on the inner wall surface between the pair of exhaust ports and the line passing through the centers of the intake ports,
wherein a fuel injector is installed in the installation hole.

14. The cylinder head as claimed in claim 8, further comprising:
an installation hole formed on the inner wall surface between the pair of exhaust ports and the line passing through the centers of the intake ports,
wherein a fuel injector is installed in the installation hole.
